(19) United States
(12) Patent Application Publication
(10) Pub. No.: US 2008/0086466 A1
(43) Pub. Date: Apr. 10, 2008

(54) Search method

(76) Inventor: Bay Baker, Cardiff (GB)

Correspondence Address: MORRISON & FOERSTER LLP, 755 PAGE MILL RD, PALO ALTO, CA, 94304-1018, US

(21) Appl. No.: 11/546,201

(22) Filed: Oct. 10, 2006

(51) Int. Cl. G06F 17/30

(52) U.S. Cl. 707/5

(57) ABSTRACT

A computer-implemented method of generating data indicating relevance of a first object to a particular criterion. The method comprises identifying a plurality of second objects referenced by said first object; determining the relevance of each of said plurality of second objects to the particular criterion; and generating data indicating the relevance of the first object to the particular criterion based upon said determination. The objects may be web pages.

### SEARCH METHOD

Computers are ubiquitous in modern society. Computers are now used for a wide range of activities in both home and work environments. In recent years, many computers have been connected together using a world wide network known as the Internet. The Internet provides users with a convenient mechanism for sharing information. More recently, use of the Internet has not been confined merely to personal computers but has been expanded so as to be provided through more portable devices such as mobile telephones and personal digital assistants. Indeed, access to the Internet is now provided using a wide range of devices, the only requirement being that such devices are provided with appropriate communications capabilities to connect to the Internet.

One particular service provided by the Internet is known as the World Wide Web. This allows users of appropriately configured computing devices to download. webpages from remote servers. Given that a large number of such servers exist, users with appropriately configured computing equipment can download a wide variety of genuinely useful information.

The very large quantity of information that is now available over the Internet has itself caused problems. Specifically, the quantity of information means that it is not possible for users to readily locate webpages of interest while disregarding webpages of little or no relevance to their current purpose. For this reason, a variety of search engines which are accessible over the World Wide Web have been established. A very well known search engine is provided by Google, Inc of California, USA. It provides a search engine which is accessible through a variety of addresses on the World Wide Web including www.google.com and www.google.co.uk.

Search engines allow users to input a search term of interest, and retrieve webpages having relevance to that term. Typically, this involves comparing a user specified search term with records in a database, the records representing pages of the World Wide Web.

Given the very large quantity of information that can now be accessed, considerable work has been done to generate effective ways of retrieving pages which are genuinely relevant to a user's requirements. In particular, considerable research effort has been expended in attempting to provide authoritative pages in response to a query, rather than pages which have little authority. For this reason, many search engines now use the page rank algorithm such that pages which are referenced from a large number of other pages are preferred to pages which are referenced from relatively few pages. That is, the page rank algorithm works on an assumption that pages which are referenced widely must be of some authoritative value. Algorithms based upon the page rank algorithm are described in EP1,517,250 (Microsoft Corporation). Although methods based upon the rank algorithm have been found to be effective, such methods typically return too many pages.

Although such methods provided by the prior art do allow user to locate pages of interest there is still a need for improved ways of determining information which is genuinely useful to a particular user.

In addition to search engines into which a user types a particular search term, the Internet provides so called directory services in which a user selects a particular category and is presented with pages pertinent to that category. Although the user is presented with a different interface it will be appreciated that such directory services can be implemented in a similar way to search engines, given that in practice a particular category selected by a user has a plurality of key words associated with it and those key words can be compared to particular webpages in a similar manner to that used by search engines as described above.

In the light of the foregoing it will be appreciated that there is a need for reliable and robust searching methods.

It is an object of the present invention to obviate or mitigate at least some of the problems set out above.

According to an aspect of the present invention, there is provided, a computer-implemented method and apparatus for generating data indicating relevance of a first object to a particular criterion. The method comprises identifying a plurality of second objects referenced by said first object, determining the relevance of each of said plurality of second objects to the particular criterion, and generating data indicating the relevance of the first object based upon said determination.

Thus, the invention provides a mechanism by which the relevance of a particular object to a particular criterion is based upon objects which are referred to by the particular object. Where objects are linked in a meaningful manner it will be appreciated that the invention allows meaning captured by links to be effectively exploited.

The term object is used broadly to cover any item or collection of information. The invention has particular applicability when the objects are webpages, where references take the form of hyperlinks. Here, it is preferred that the first object is associated with a first domain while the second object is associated with a second domain. The first object is likely to reference third objects which are also associated with the first domain. Hyperlinks to the third objects may be processed to obtain further detail relating to the relevance of the first object to the particular criterion. In this way, information indicating the relevance of a particular webpage to a particular criterion is obtained by processing the content of referenced pages associated with other domains, whilst processing hyperlinks referencing pages within the domain of the first webpage.

When hyperlinks are processed to determine relevance, this can be done in any convenient way. For example the anchor text or <alt> tag of a hyperlink may be processed with reference to the criterion.

The criterion may be based upon user input. The method may further comprise receiving textual input data, and generating said criterion based upon said textual input data. Alternatively, the method may comprise receiving input data representing user selection of one of a plurality of categories and determining one or more criteria based upon said category.

Preferably a plurality of categories are predefined. Data defining the plurality of categories may be read, each category being associated with at least one criterion. The relevance of an object to each category can then be determined based upon the or each criterion associated with each category. Data indicating the relevance of each object to each category may be stored. The method may further comprise receiving user input data specifying content of interest, receiving user input selecting one of said plurality of categories, and retrieving objects based upon said input data and the relevance of objects to said selected category. The user input data may comprise a text string.

A further aspect of the invention provides a computer-implemented method of generating data indicating relevance of a first object to a plurality of criteria, the method comprises: identifying a plurality of second objects referenced by said first object; determining the relevance of each of said plurality of second objects to each of said plurality of criteria; storing data indicating the relevance of the first object to each of said criteria based-upon said determination; receiving user input indicating a criterion of interest; and generating output data based upon said criterion of interest and the relevance of said objects to said criterion of interest.

The invention further provides a method for determining relevance of a first webpage to a particular criterion, the method comprising: identifying a plurality of second web pages referenced by said first web page; determining the relevance of each of said plurality of second web pages to the particular criterion; and generating data indicating the relevance of the first web page based upon said determination.

There is also provided a method for determining relevance of a first webpage associated with a first domain to a particular criterion, the method comprising: identifying a plurality of web pages referenced by said first web page, each of said web pages being referenced by respective hyperlinks, and said plurality of referenced web pages comprising second web pages associated with a second domain, and third web pages associated with said first domain; determining the relevance of each of said plurality of second web pages to the particular criterion; and generating data indicating the relevance of the first web page based upon said determination.

The invention also provides a method of generating a database storing information representing the relevance of each of a plurality of first objects to a plurality of categories, the method comprises, for each first object for each category: identifying a plurality of second objects referenced by said first object; determining the relevance of each of said plurality of second objects to the particular criterion; and storing data indicating the relevance of the first object to the particular category based upon said determination.

Once such a database has been established, such a database can be accessed over the Internet, thus allowing search operations to be carried out. In particular, the method may comprise receiving a search criterion and searching a database based upon said search criterion, said database being generated using a method as set out above.

It will be appreciated that features described or claimed with reference to one aspect of the invention can be similarly applied to other aspects of the invention. It will further be appreciated that all aspects of the invention can be implemented by way of methods, apparatus, and computer programs. Such computer programs can be carried on suitable carrier media including CDROMs and communication signals.

Embodiments of the present invention will now be described, by way of example, with reference to the accompanying drawings, in which:

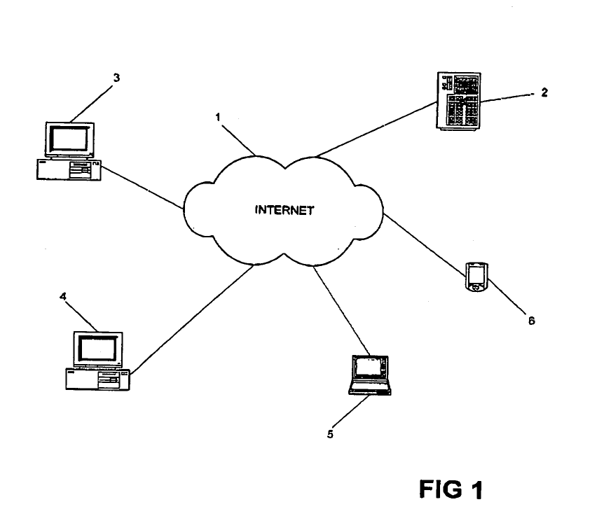

FIG. 1 is a schematic illustration of a computer network on which embodiments of the present invention can be implemented;

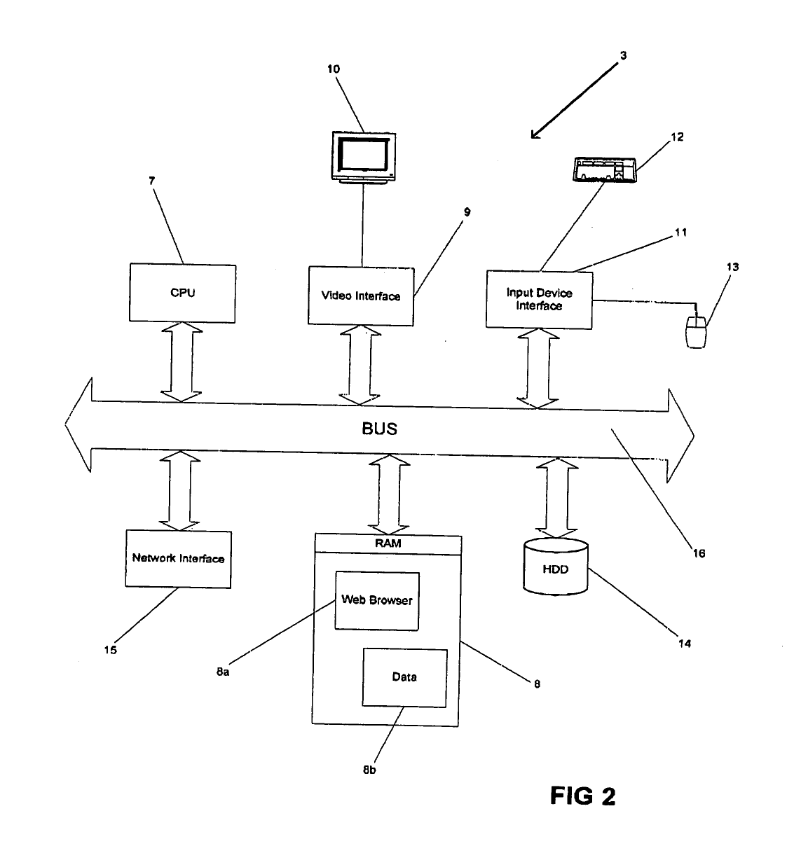

FIG. 2 is a schematic illustration of a computer apparatus shown in FIG. 1;

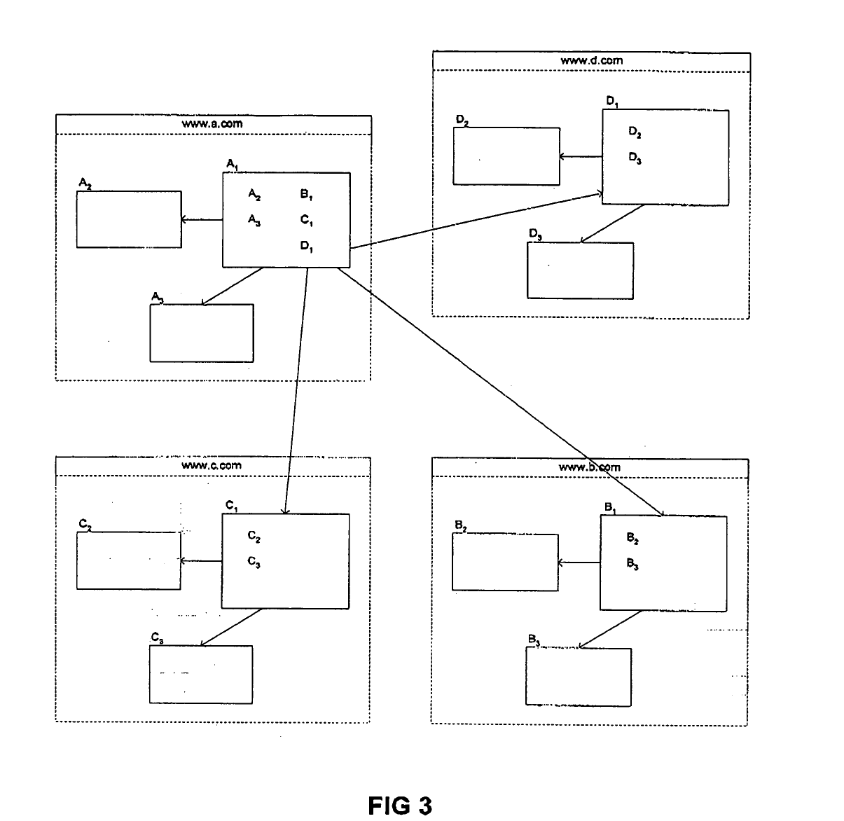

FIG. 3 is a schematic illustration of a process for determining relevance of a webpage in accordance with an embodiment of the invention;

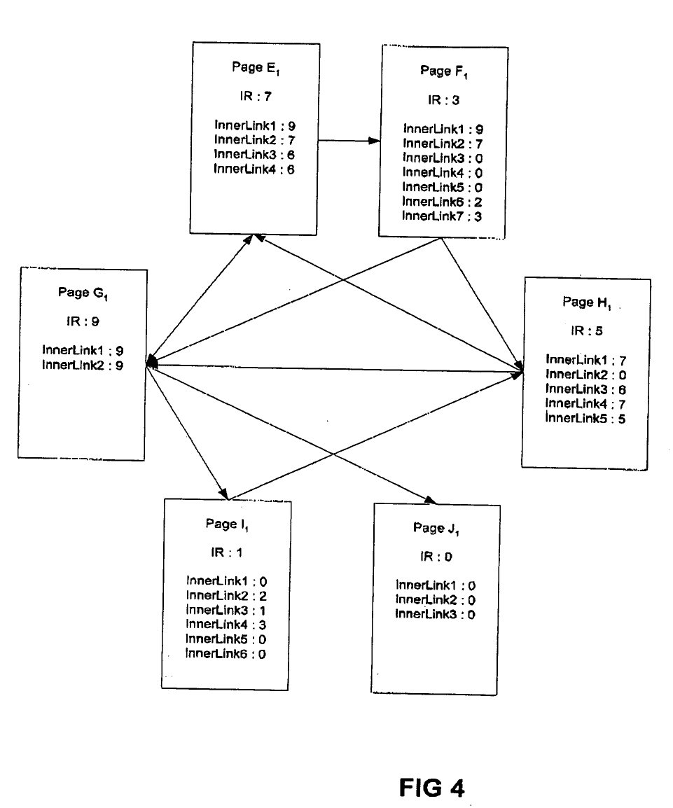

FIG. 4 is a schematic illustration of a further exemplary embodiment of the invention;

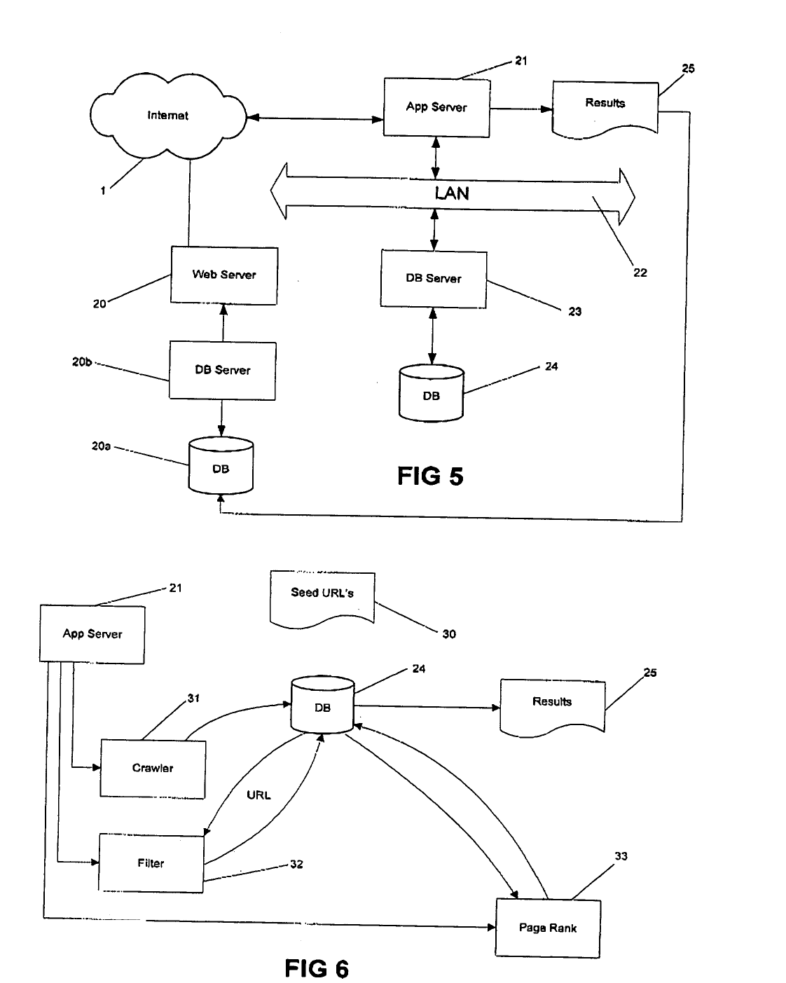

FIG. 5 is a schematic illustration of an apparatus suitable for implementing the present invention;

FIG. 6 is a schematic illustration of components used to implement an embodiment of the present invention;

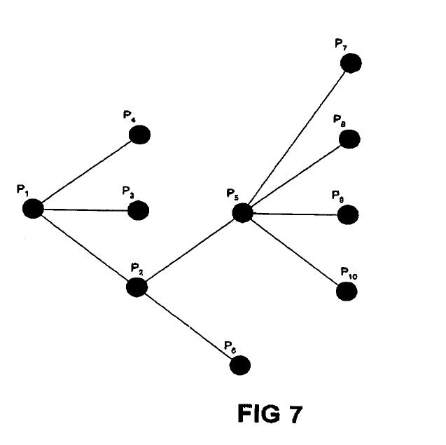

FIG. 7 is a schematic illustration of webpages and their interrelationships;

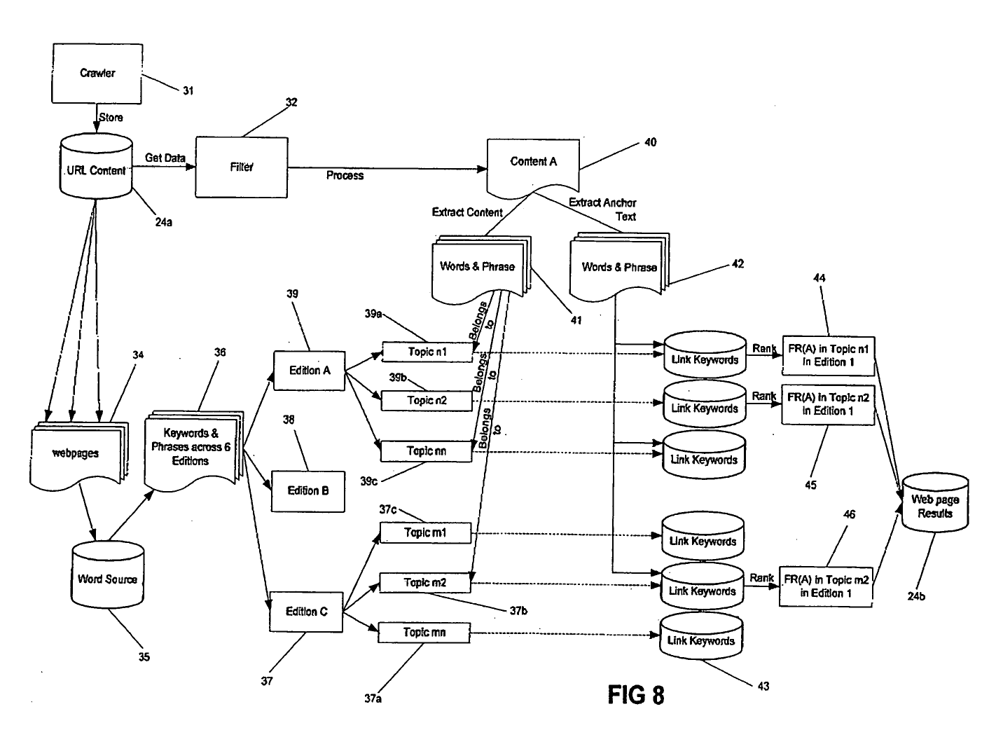

FIG. 8 is a schematic illustration of components used to implement an embodiment of the invention; and

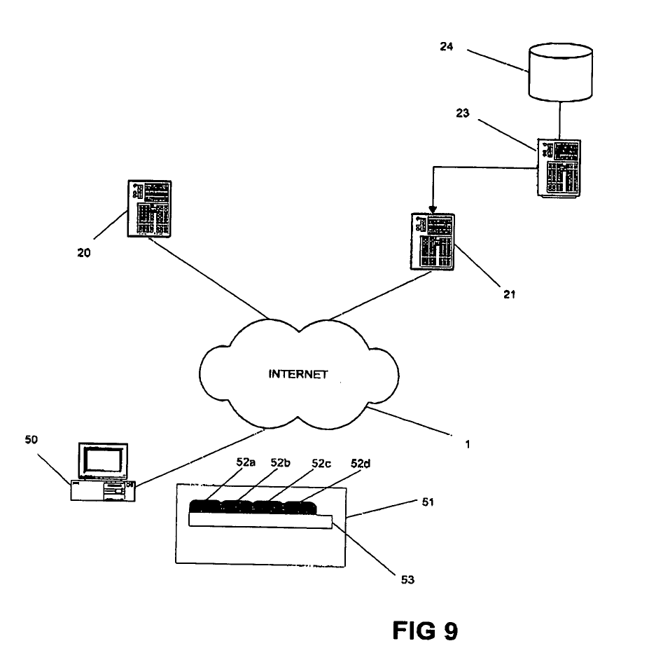

FIG. 9 is a schematic illustration of a computer network configured to allow search operations to be carried out.

Referring first to FIG. 1, there is illustrated a computer network comprising a plurality of computers connected to the Internet 1. It can be seen that a server 2 is connected to the Internet 1 as are PCs 3, 4, a laptop 5, and a portable computing device 6. Each of the PCs 3, 4 the Laptop 5, and the portable computing device 6 are provided with means to access the Internet 1. In this way, communication is enabled between the PCs 3, 4, the laptop 5, the portable computing device 6 and the server 2. For example, the laptop 5 may be provided with web browser software which allows webpages provided by the server 2 to be downloaded over the Internet 1 for display on the laptop 5. Similar web browser software may be provided on the PCs 3, 4, and on the portable computing device 6. In this way, various devices are able to access information provided by the server 2 over the Internet 1.

It will be appreciated that the devices shown in FIG. 1 may be connected to the Internet 1 in any convenient way. For example, the PC 4 may be provided with a modem (not shown) allowing connection to a remote computer, the remote computer in turn being connected to the Internet. The PC 3 may be connected to a local area network (LAN) (not shown). A computer may be connected to the LAN and also connected to the Internet 1, thereby providing the PC 3 with access to the Internet 1. It will be appreciated that various other forms of communication between the computing devices shown in FIG. 1 and the Internet 1 can similarly be provided.

As will be appreciated by one of ordinary skill in the art, a plurality of servers are connected to the Internet 1. If each of these servers provides webpages which can be accessed by appropriately configured computing devices, users of the PC's 3, 4, the laptop 5, and the portable computing device 6 have ready access to a large quantity of information provided by the plurality of servers. This means that the Internet provides a useful and wide ranging information source which any computer with Internet connectivity can access.

Referring to FIG. 2, the architecture of the PC 3 is described in further detail. It will be appreciated that the PC 4 can have an identical architecture. It can be seen from FIG. 2 that the PC 3 includes a CPU 7 configured to execute instructions provided to it. Such instructions are stored in volatile storage, taking the form of RAM 8. It can be seen from FIG. 2 that the RAM 8 stores processor executable instructions and data useable by such instructions. Specifically, it can be seen that the RAM 8 stores a web browser program 8a comprising a plurality of processor executable instructions alongside data 8b useable by the instructions of the web browser program 8a.

The PC 3 additionally comprises a video interface 9 which provides connection to a display device 10. The display device can take any convenient form, and can suitably take the form of a flat panel display. Additionally, the PC 3 comprises an input device interface 11 to which input devices in the form of a keyboard 12 and a mouse 13 are connected. In this way, a user can interact with the PC 3 using the keyboard 12 and the mouse 13. It will be appreciated that other input and output devices can be used.

The PC 3 additionally comprises non-volatile storage in the form of a hard disk drive 14. Further, the PC 3 comprises a network interface 15 allowing access to a computer network. Using the network interface 15 the PC 3 is able to connect to a local area network (not shown), the local area network in turn being connected to the Internet 1. In this way, the PC 3 is provided with access to the Internet by the network interface 15. It can be seen that the CPU 7, the video interface 9, the input device interface 11, the network interface 15, the RAM 8 and the hard disk drive 14 are connected by a bus 16 allowing data to travel between the various components.

It was indicated which reference to FIG. 1 above, that a plurality of servers are connected to the Internet 1 which are accessible to appropriately configured computing devices to provide access to a wide range of information. It can be seen from FIG. 2 that the PC 3 is indeed an appropriately configured computing device. Specifically, the network interface 15 of the PC 3 allows connection to the Internet, and information provided by servers connected to the Internet can be navigated and downloaded using the web browser program 8a stored in the RAM 8. Data downloaded for display by the PC 3 is stored in the form of the data 8b.

An embodiment of the present invention allowing the relevance of particular information to a particular criterion to be determined is now described, first with reference to FIG. 3.

FIG. 3 shows a plurality of webpages provided by servers connected to the Internet 1. It can be seen that the webpages shown in FIG. 3 are taken from four distinct domains, that is www.a.com, www.b.com, www.c.com, and www.d.com. It can be seen that in FIG. 3 each of the domains is shown as having three pages. It will be appreciated that in practice each domain will usually provide more than three pages.

It can be seen from FIG. 3 that the domain www.a.com comprises a first page A₁. The page A₁ includes a plurality of hypertext links, which when selected cause the display of another page. It can be seen from FIG. 3 that the page A₁ includes links to pages A₂ and A₃ which are provided by the domain www.a.com. Additionally, the page A₁ includes hypertext links which when selected respectively cause the display of pages B₁, C₁ and D₁. The page B₁, is provided by the domain www.b.com, while the page C₁ is provided by the domain www.c.com, and the page D₁ is provided by the domain www.d.com. Thus, it can be seen that the page A₁ includes links to other pages within the domain www.a.com (that is pages A₂ and A₃) as well as links to pages provided by other domains (that pages B₁, C₁ and D₁). Links to the pages A₂ and A₃ from the page A₁ are referred to as “inner links” given that they are pages within the domain of the page A₁, that is the domain www.a.com. In contrast, the links to pages B₁, C₁ and D₁ are referred to as “outer links” given that they are links targeting pages which are provided by domains other than the domain www.a.com.

A method is now described which is usable to determine the relevance of page A₁ to a particular criterion. This method involves processing both inner links and outer links, although these different types of links are processed in different ways. Considering first the inner links which target pages A₂ and A₃, these links are processed to generate data indicating the relevance of the page A₁. Specifically, anchor text associated with the links to pages A₂ and A₃ is compared to particular keywords as is described in further detail below. This process generates an inner rank for the page A₁.

Given that the outer links to pages B₁, C₁ and D₁ target pages not provided by the domain www.a.com, the anchor text of these links is not processed. Rather, the pages B₁, C₁ and D₁ which are targeted by the links within the page A₁ are processed. This processing generates an outer rank for the page A₁. The inner rank and outer rank are then combined so as to provide an overall rank for the page A₁ with reference to the particular criterion of interest.

In general terms, while the inner rank for page A₁ is generated by processing anchor text associated with the links to the pages A₂ and A₃, the outer rank for page A₁ based upon the links to pages B₁, C₁ and D₁ is generated by processing the inner ranks of the pages B₁, C₁ and D₁ respectively. That is, using page B₁, as an example the inner links of page B₁, (which target pages B₂ and B₃ within the domain www.b.com) are processed with reference to their anchor text so as to determine the inner rank of page B₁. Similar processing is carried out for the pages C₁ and D₁. The inner ranks of the pages B₁, C₁ and D₁ are combined so as to generate an outer rank for the page A₁.

The generation of inner and outer ranks is now described in further detail with reference to the example of FIG. 4.

It can be seen in FIG. 4 that six webpages are shown, each webpage being part of a distinct domain. Specifically, a page E₁ is provided by domain www.e.com, a page F₁ is provided by the domain www.f.com, a page G₁ is provided by the domain www.g.com, a page H₁ is provided by the domain www.h.com, a page I₁ is provided by the domain www.i.com while a page J₁ is provided by the domain www.j.com. It can be seen from FIG. 4 that each of the six illustrated pages includes a plurality of inner links, that is links to other pages provided by the domain within which the page is located. Thus, it can be seen that the page E₁ includes four inner links, the page F₁ includes seven inner links, the page G₁ includes two inner links, the page H₁ includes five inner links, the page I₁ includes six inner links and the page J₁ includes three inner links. As indicated above, in order to calculate inner ranks for the various pages the anchor text of the inner links is processed. This processing involves comparing a particular text indicating a criterion of interest with anchor text associated with each inner link. Thus, for example, if a search to locate pages relating to cars is being carried out key words such. as “car”, “vehicle”, and “transport” may be specified as a set of key words. The anchor text of each inner link is then compared to the set of key words to generate a score for each inner link respectively. These scores are shown alongside respective inner links in the diagram of FIG. 4. The computation of inner link scores is described in further detail below.

Having computed a score for each inner link within a particular page, an inner rank can be computed by adding the scores of the inner links and dividing the sum by the number of inner links. That is, the inner rank for the page E₁ is computed by adding the scores associated with its four inner links and dividing the result of that sum by 4. Thus, the inner rank of page E₁ is given by:

$$\frac{9 + 7 + 6 + 6}{4} = 7 \qquad ( 1 )$$

Thus, the inner rank of page E₁ is 7.

Similarly, it can be seen from FIG. 4 that the seven inner links on page F₁ have scores of 9, 7, 0, 0, 0, 2 and 3 respectively. Thus, the inner rank of the page F₁ is computed by:

$$\frac{9 + 7 + 0 + 0 + 0 + 2 + 3}{7} = 3 \qquad ( 2 )$$

Similarly, the inner rank of the page G₁ is computed by:

$$\frac{9 + 9}{2} = 9 \qquad ( 3 )$$

For page H₁ the inner rank is given by:

$$\frac{7 + 0 + 6 + 7 + 5}{5} = 5 \qquad ( 4 )$$

For page I₁ the inner rank is computed by:

$$\frac{0 + 2 + 1 + 3 + 0 + 0}{6} = 1 \qquad ( 5 )$$

while for page J₁, the inner rank is computed by:

$$\frac{0 + 0 + 0}{3} = 0 \qquad ( 6 )$$

Thus, by computing a score for each inner link and averaging the values of the inner links, an inner rank for each page can be computed.

It was explained above, that the described method also uses an outer rank, that is a rank obtained by processing data associated with pages provided by other domains which are linked from a particular page. Thus, considering the page E₁ it can be seen that the page E₁ includes outer links to pages F₁, and G₁. This means that the outer rank of page E₁ is given by taking the inner ranks of the pages F₁, and G₁ and averaging these inner ranks. That is, the outer rank for page E₁ is given by:

$$\frac{9 + 3}{2} = 6 \qquad ( 7 )$$

Thus, the page E₁ has an inner rank of 7 and an outer rank of 5.66. In order to compute an overall rank for page E₁ the inner and outer ranks are combined. This is preferably achieved in accordance with the following equation:

SR(E₁)=(1−α)IR(E₁)+(α)OR(E₁) (8)

### Where:

α is a scaling factor, which is 0.5 in some embodiments;
IR(E₁) is the inner rank of page E₁;
OR(E₁) is the outer rank of page E₁;
SR(E₁) is the overall rank of page E₁.

Thus, the overall rank of the page E₁ is:

(1−0.5)×7+0.5*56=6.5 (9)

Similar computations can be carried out to deduce overall ranks for other pages shown in FIG. 4.

The computations presented above can be specified in general terms for a page X including M inner links and N outer links. In such a case, the overall rank for the page X is given by equation (10):

SR(X)=(1−α)IR(X)+αOR(X) (10)

where:
α is as defined above;
IR(X) is the inner rank of X; and
OR(X) is the outer rank of X.

The inner rank of page X is computed by processing all inner links on the page X. This is given by equation (11):

$$IR ( X ) = \frac{{\sum }_{i = 1}^{M} S ( {IL}_{i} )}{M} \qquad ( 11 )$$

where:
M is the number of inner links;
ILᵢ is the i^{th} inner link; and
S(b) is a function providing a score for inner link b based upon the criterion of interest.

The outer rank of the page X is given by equation (12):

$$OR ( X ) = \frac{{\sum }_{i = 1}^{N} IR ( {W}_{i} )}{N} \qquad ( 12 )$$

where:
Wᵢ is the i^{th} page targeted by an outer link on the page X.

Thus, from the preceding description it will be appreciated that the described embodiment provides a convenient mechanism for determining the relevance of a particular page to a particular criterion by processing both links on that page to other pages within its domain as well as processing links to pages outside its domain. In this way, an indication of the relevance of a particular page to a particular criterion can be derived.

In general terms, the particular criterion of interest can be specified in a number of ways. For example, a user may be presented with a webpage into which the criterion is typed. Data stored by a server may then be processed with reference to this criterion using the method described above so as to determine the relevance of particular webpages to the particular criterion. Alternatively, the particular criterion may be associated with a particular category. That is, categories such as travel, holidays and cars may be specified each having a plurality of associated criteria. When a particular one of the categories is selected a search is carried out for data relevant to the criteria using data stored on a server. This is described in further detail below.

Referring first to FIG. 5, it can be seen that a web server 20, and an application server 21 are both connected to the Internet 1. The web server 20 provides a plurality web pages over the Internet 1. The web server obtains data from a database server 20b which manages a database 20a. The application server 21 is connected to a local area network 22, as is a database server 23. The database server 23 manages a database 24. The database 24 can be accessed by applications running on the application server 21, by the application server making appropriate requests to the database server 23 over the LAN 22. In this way, the application server 21 is able to retrieve data from the database 24, and such data can be output by applications running on the application server 21 in the form of results, schematically illustrated at 25. The results can be stored in the database 20a. In this way the database server 20b can extract preloaded results from the database 20a. The configuration shown in FIG. 5 can be used to apply the processing described above with reference to FIGS. 3 and 4 so as to determine the relevance of particular data. Specifically, a process for retrieving data from the Internet, storing that data in a database and subsequently retrieving data from that database so as to identify data on the Internet being relevant to particular criteria is described with reference to FIG. 6.

Referring to FIG. 6 seed URLs 30 identifying initial webpages are provided. The use of seed URLs is described in further detail below. This set of seed URLs is used to determine webpages which a crawler module 31 running on the application server 21 will visit in a first instance. Essentially, the seed URLs represent starting points for a “crawl” of the Internet, the exact nature of the crawl being defined by links on those seed URLs. That is, referring to FIG. 7, if one of the seed URLs is a page P₁, having retrieved data from page P₁ data is then retrieved from pages P₂, P₃ and P₄ all of which are linked from page P₁. Having retrieved data from the pages P₂, P₃ and P₄ data is then retrieved from the pages P₅ and P₆ which are linked from page P₂. Subsequently, data is retrieved from the pages P₇, P₈, P₉ and P₁₀ all of which are linked from the page P₅. Thus, a process is established beginning with a seed URL in which a breadth first search is carried out so as to retrieve appropriate webpages. Appropriate webpages retrieved are stored in the database 24. Such webpages are stored by storing an associated URL together with details of the URL source, the title, the metatags and the body of the page. It is this data which forms the basis for operations carried out using the process shown in FIGS. 3 and 4.

The application server 21 operates a filter module 32 which interacts with the database 24. The filter module applies processing as described above with reference to FIGS. 3 and 4 so as to identify pages of relevance to a particular criterion. Thus, the filter 32 will typically provide results 25 which represent pages having acceptable similarity-to the required criterion. This will typically comprise determining an overall rank for each page, and generating results comprising pages which have an overall rank above a particular threshold, or alternatively taking a predetermined number of pages having the highest rank.

It will be appreciated that it is preferable that retrieved results are presented in a meaningful order. Thus, the application server 21 also communicates with a module 33 configured to implement an algorithm similar to the well known page rank algorithm so as to order results by a metric relating to their authoritative value. The module implementing the page rank algorithm 33 communicates with the database and affects the generation of the results 25.

The processing described above with reference to FIG. 6 and 7 is now described in further detail with reference to FIG. 8. It can be seen that the Crawler module 31 retrieves a plurality of webpages from the Internet 1 and forms a URL content database 24a. This process is based upon a plurality of seed URLs as described above. Specifically, using a set of key words a plurality of URLs can be created from which attempts are made to obtain webpages. Subsequently, links to other pages provided by those pages can be used to continue the “crawl” of the Internet. The URL content database 24a comprises a plurality of webpages 34. These pages are parsed so as to extract from their text constituent keywords and phrases. Such extracted keywords or phrases are stored in a matrix source database 35. The matrix source database 35 is used to update a data store 36 which is initialised to include standard words and phrases in a particular language, English in the described embodiment 36. In alternative embodiments the data store may store words and phrases from a plurality of different languages, thereby allowing the method to be applied to multilingual data. Each of the words and phrase in the data store 36 is associated with a particular edition, an edition being defined by a particular area of interest. It can be seen that three editions 37, 38, 39 are shown in FIG. 8. The editions 37 and 39 both have associated topics, being more specific subsets of content associated with a particular edition. Specifically, it can be seen that the edition 37 has topics 37a, 37b and 37c while the edition 39 has topics 39a, 39b, 39c. Again, each of these topics has associated words and phrases.

In this way a plurality of distinct areas of interest can be defined hierarchically, each area of interest being associated with particular words and phrases. It can be seen that the Filter module 32 also communicates with the URL content database 24a. The Filter module 32 processes each page of the web pages 34 to determine one or more editions,. (and topics where appropriate), with which a particular page is to be associated. Specifically, as can be seen in FIG. 8, a particular page 40 is processed so as to extract words and phrases 41 appearing on that page and anchor text words and phrases 42 appearing on that page. As described above, each topic and edition is associated with a plurality of words and phrases taken from the words and phrases 36. Thus, the words and phrases 41 are used to associate the page 40 with a particular edition and topic based upon the words and phrases associated with each edition and topic.

Additionally, the anchor text words and phrases 42 are compared with particular link keywords 43 so as to generate a score for each inner link. That is, the anchor text words and phrases 42 are processed so as to extract inner links which are then compared to the link keywords 43. This allows the generation of scores for each of the inner links on a particular page and consequently an inner rank for each page based upon keywords associated with a particular topic. Such processing has been described above. Having generated inner ranks for each page on this basis, outer ranks can then be computed by computing the inner rank of linked pages as described above. In this way an overall rank associated with a first topic 44 an overall rank associated with a second topic 45 and an overall rank associated with a third topic 36 can be computed. The editions and topics for which an overall rank is computed can be determined using the words and phrases 41. These ranks are then stored in a database 24b.

Thus, it can be seen that the method of ranking pages using inner and outer ranks as described above can be used so as to determine a rank of each page associated with a plurality of editions and topics. Thus, a plurality of categories in which users may frequently want to search can be defined and each webpage retrieved by the crawler module will have a rank associated with at least some of these categories. Thus, when a user inputs a particular search term of interest, search results associated with a particular category and further associated with that search term can be retrieved. Retrieving pages associated with a particular keyword can be based upon a search of body text on each page associated with a particular topic, the association with particular topics can be determined by rank.

It was described above that link keywords 43 were compared with each inner link to determine a score for each inner link and consequently an inner rank as described above. The set of link keywords for a particular topic is created by searching the URL content 24a using words and phrases taken from the words and phrases 36 associated with each topic in turn. The most commonly occurring words on pages returned by this search are then stored to form the link keywords 43. Before determining the most commonly occurring words it often desirable to remove common phrases such as “about us” and “contact us” which provide little useful information as to the relationship between a page and a particular topic.

It has been indicated above with reference to FIG. 8 that a rank can be determined for each of a plurality of webpages for each of a plurality of categories. Such rank information can be stored in a database such that searches of the type described above can be carried out. Specifically, a user using a PC 50 connected to the Internet 1 accesses a webpage provided by a search engine provider operating the webserver 20. The user is presented with webpage providing a user interface 51, allowing the selection of one of a plurality of categories 52a, 52b, 52c, 52d. The user interface 51 additionally allows a search term to be entered into a text box 53. When the user uses the user interface 51 to select a category and input a search term, relevant data so input is transmitted back to the webserver 20. The information provided by the user (both a category selection and a search term) are passed to the application server 21, which communicates with the database server 23 managing the database 24. The application server requests that the database server 23 performs a search of the database 24 to locate stored webpages associated with the input search term, and having a sufficiently high rank based upon the specified category. Results of this search are then communicated to the PC 50 via the webserver 20.

In addition to using methods described above to determine the relevance of a particular webpage it will be appreciated that other methods can also be used. For example, it will be appreciated that the particular criterion of interest specified in terms of one or more keywords may be compared to text on a particular page to determine the relevance of that page. Such comparison may involve body text on page and may also involve tags such as meta tags. Additionally although it has been explained that the inner rank of outer linked pages is used to determine the relevance of a particular page it will be appreciated that the inner rank of inner linked pages may also be used in some embodiments of the invention.

Embodiments of the invention may be implemented using any convenient programming languages and platforms. In a preferred embodiment, the invention is implemented on a Linux environment using a database provided by MySQL, and a computer program written in C++ and PHP.

Where reference has been made above to the processing of anchor text, it will be appreciated that links based upon images may be processed with reference to their alt tags. Furthermore, in some embodiments the source of links may be processed.

It will be appreciated that methods described herein can be implemented on any suitable computing device including portable devices such as mobile telephones and PDAs. The methods described herein can be used in connection with any “electronic media” that being media that utilises electronic or electromechanical energy for the end user to access content. That is, the described methods could be used to access audio recordings, data stored on CD-ROMs slide presentation etc.

Although preferred embodiments of the invention have been described above, it will be appreciated that various modifications can be made without departing from the spirit and scope of the invention as defined by the appended claims.

In particular, although embodiments of the present invention have been described with reference to the Internet, it will be appreciated that embodiments of the invention are in no way restricted to the Internet, or indeed to any computer network. Indeed, searching methods such as those described here are equally applicable to use in standalone databases which are not provided with network connectivity.

1. A computer-implemented method of generating data indicating relevance of a first object to a particular criterion, the method comprising:
identifying a plurality of second objects referenced by said first object;
determining the relevance of each of said plurality of second objects to the particular criterion; and
generating data indicating the relevance of the first object to the particular criterion based upon said determination.

2. A method according to claim 1 further comprising determining relevance of said first object based upon data within said first object.

3. A method according to claim 2, wherein said data within said first object comprises references to third objects.

4. A method according to claim 3, wherein said first and third objects are members class of objects, and said second objects are members of a second distinct class of objects.

5. A method according to claim 1, wherein determining the relevance of each of said plurality of second objects comprises processing data within each of said second objects with reference to the particular criterion.

6. A method according to claim 5, wherein processing data within each of said second objects comprises processing references to further objects from said second objects.

7. A method according to claim 1 wherein said objects are webpages.

8. A method according to claim 7 wherein said second objects are referenced by said first object using first hyperlinks.

9. A method according to claim 7, wherein said third objects are referenced by said first object using second hyperlinks.

10. A method according to claim 9, comprising processing said second hyperlinks to determine relevance of said first object.

11. A method according to claim 10, wherein processing said second hyperlinks comprises processing anchor text associated with said second hyperlinks.

12. A method according to claim 10, wherein processing said second hyperlinks comprises processing alt tags associated with said second hyperlinks.

13. A method according to claim 7, wherein said first objects are associated with a first domain, and said second objects are associated with a second distinct domain.

14. A method according to claim 13, wherein said data within said first object comprises references to third objects and said third objects are associated with said first domain.

15. A method according to claim 7, wherein said second objects reference further objects using further hyperlinks, and said further hyperlinks are processed to determine the relevance of a particular second object.

16. A method according to claim 15, wherein processing said further hyperlinks comprises processing anchor text associated with said second hyperlinks.

17. A method according to claim 15, wherein processing said further hyperlinks comprises processing alt tags associated with said second hyperlinks.

18. A method according to claim 1, wherein said objects are stored in a database.

19. A method according to claim 18, further comprising: retrieving said objects over the Internet and storing said objects in said database.

20. A method according to claim 1, wherein said criterion is based upon user input.

21. A method according to claim 20, further comprising:
receiving textual input data; and
generating said criterion based upon said textual input data.

22. A method according to claim 20, further comprising:
receiving input data representing user selection of one of a plurality of categories; and
determining one or more criteria based upon said category.

23. A method according to claim 1, further comprising:
reading data defining a plurality of categories, each category being associated with at least one criterion; and
determining the relevance of an object to each category based upon the or each criterion associated with each category.

24. A method according to claim 23, further comprising storing data indicating the relevance of each object to each category.

25. A method according to claim 24, further comprising:
receiving user input data specifying content of interest;
receiving user input selecting one of said plurality of categories; and
retrieving objects based upon said input data and the relevance of objects to said selected category.

26. A method according to claim 25, wherein said user input data comprises a text string.

27. A method according to claim 26, further comprising comparing contents of objects to said text string to retrieve objects based upon said input data.

28. A method according to claim 23, further comprising processing a plurality of objects to determine the or each criterion associated with each of said categories.

29. A method according to claim 28, wherein said processing said plurality of objects comprises determining a plurality of terms included in pages associated with a particular category, and using said plurality of terms to define the or each criterion.

30. A method according to claim 29, wherein a plurality of criteria are associated with each category, said plurality of criteria being selected based upon terms most commonly occurring within objects in said category.

31. Apparatus for generating data indicating relevance of a first object to a particular criterion, the apparatus comprising:
means for identifying a plurality of second objects referenced by said first object;
means for determining the relevance of each of said plurality of second objects to the particular criterion; and
means for generating data indicating the relevance of the first object to the particular criterion based upon said determination.

32. Apparatus according to claim 31, further comprising means for determining relevance of said first object based upon data within said first object.

33. Apparatus according to claim 32, wherein said data within said first object comprises references to third objects.

34. Apparatus according to claim 31, wherein said first and third objects are members of a first class of objects, and said second objects are members of a second distinct class of objects.

35. Apparatus according to claim 31, wherein said means for determining the relevance of each of said plurality of second objects comprises means for processing data within each of said second objects with reference to the particular criterion.

36. Apparatus according to claim 35, wherein said means for processing data within each of said second objects comprises means for processing references to further objects from said second objects.

37. Apparatus according to claim 31, wherein said objects are webpages.

38. Apparatus according to claim 37 wherein said second objects are referenced by said first object using first hyperlinks.

39. A method according to claim 37, wherein said data within said first object comprises references to third objects and said third objects are referenced by said first object using second hyperlinks.

40. Apparatus according to claim 39, comprising means for processing said second hyperlinks to determine relevance of said first object.

41. Apparatus according to claim 40, wherein said means for processing said second hyperlinks comprises is configured to process anchor text associated with said second hyperlinks.

42. Apparatus according to claim 40, wherein said means for processing said second hyperlinks is configured to process alt tags associated with said second hyperlinks.

43. Apparatus according to claim 37, wherein said first objects are associated with a first domain, and said second objects are associated with a second distinct domain.

44. Apparatus according to claim 43, wherein said data within said first object comprises references to third objects and said third objects are associated with said first domain.

45. Apparatus according to claim 37, wherein said second objects reference further objects using further hyperlinks, and said apparatus comprises means for processing said further hyperlinks to determine the relevance of a particular second object.

46. Apparatus according to claim 45, wherein said means for processing said further hyperlinks comprises means for processing anchor text associated with said second hyperlinks.

47. Apparatus according to claim 45, wherein said means for processing said further hyperlinks comprises means for processing alt tags associated with said second hyperlinks.

48. Apparatus according to claim 31, further comprising a database, wherein said objects are stored in a database.

49. Apparatus according to claim 48, further comprising: means for retrieving said objects over the Internet and storing said objects in said database.

50. Apparatus according to claim 31, wherein said criterion is based upon user input.

51. Apparatus according to claim 50, further comprising:
means for receiving textual input data; and
means for generating said criterion based upon said textual input data.

52. Apparatus according to claim 50, further comprising:
means for receiving input data representing user selection of one of a plurality of categories; and
means for determining one or more criteria based upon said category.

53. Apparatus according to claim 31, further comprising:
means for reading data defining a plurality of categories, each category being associated with at least one criterion; and
means for determining the relevance of an object to each category based upon the or each criterion associated with each category.

54. Apparatus according to claim 53, further comprising means for storing data indicating the relevance of each object to each category.

55. Apparatus according to claim 54, further comprising:
means for receiving user input data specifying content of interest;
means for receiving user input selecting one of said plurality of categories; and
means for retrieving objects based upon said input data and the relevance of objects to said selected category.

56. Apparatus according to claim 55, wherein said user input data comprises a text string.

57. Apparatus according to claim 56, further comprising means for comparing contents of objects to said text string to retrieve objects based upon said input data.

58. Apparatus according to claim 53, further comprising means for processing a plurality of objects to determine the or each criterion associated with each of said categories.

59. Apparatus according to claim 58, wherein said means for processing said plurality of objects comprises means for determining a plurality of terms included in pages associated with a particular category, and said processing is configured to use said plurality of terms to define the or each criterion.

60. A method according to claim 59, wherein a plurality of criteria are associated with each category, said plurality of criteria being selected based upon terms most commonly occurring within objects in said category.

61. A computer readable medium storing computer readable instructions configured to control a computer to carry out a method according to claim 1.

62. A computer apparatus for determining relevance of an object, the apparatus comprising:
a memory storing processor readable instructions; and
a processor configured to read and execute instructions stored in said first memory;
wherein the processor readable instructions comprise instructions controlling the computer to carry out a method according to claim 1.

63. A computer-implemented method of generating data indicating relevance of a first object to a plurality of criteria, the method comprising:
identifying a plurality of second objects referenced by said first object;
determining the relevance of each of said plurality of second objects to each of said plurality of criteria;
storing data indicating the relevance of the first object to each of said criteria based upon said determination;
receiving user input indicating a criterion of interest; and
generating output data based upon said criterion of interest and the relevance of said objects to said criterion of interest.

64. A method according to claim 63, further comprising transmitting said input indicating a criterion of interest from a first computer to a remote computer, said remote computer being configured to generate said output data.

65. A method for determining relevance of a first webpage to a particular criterion, the method comprising:
identifying a plurality of second web pages referenced by said first web page;
determining the relevance of each of said plurality of second web pages to the particular criterion; and
generating data indicating the relevance of the first web page based upon said determination.

66. A method for determining relevance of a first webpage associated with a first domain to a particular criterion, the method comprising:
identifying a plurality of web pages referenced by said first web page, each of said web pages being referenced by respective hyperlinks, and said plurality of referenced web pages comprising second web pages associated with a second domain, and third web pages associated with said first domain;
determining the relevance of each of said plurality of second web pages to the particular criterion; and
generating data indicating the relevance of the first web page based upon said determination.

67. A method according to claim 66, further comprising processing hyperlinks referencing said third web pages to determine relevance of said first web page.

68. Apparatus for generating data indicating relevance of a first object to a particular criterion, the apparatus comprising:
a processor configured to identify a plurality of second objects referenced by said first object, to determine the relevance of each of said plurality of second objects to the particular criterion, and to generate data indicating the relevance of the first object to the particular criterion based upon said determination.

69. A method of generating a database storing information representing the relevance of each of a plurality of first objects to a plurality of categories, the method comprising, for each first object for each category:
identifying a plurality of second objects referenced by said first object;
determining the relevance of each of a plurality of second objects to the particular criterion; and
storing data indicating the relevance of the first object to the particular category based upon said determination.

70. A method according to claim 69, wherein said objects are webpages.

71. A method according to claim 70, wherein said first objects are associated with a first domain and said second objects are associated with a second distinct domain.

72. A method according to claim 71, wherein said first objects reference respective third objects, said third objects being web pages associated with said first domain.

73. A method according to claim 72, further comprising processing references to said third objects to determine the relevance of a respective first object.

74. A method according to claim 69, wherein said references are hyperlinks.

75. A method of conducting a search operation, the method comprising:
receiving a search criterion;
searching a database based upon said search criterion, said database being generated using a method according to claim 69.

76. A method according to claim 75, further comprising, transmitting said search criterion from a first computer to a remote computer, said remote computer being configured to cause said searching.
